(19) United States
(12) Patent Application Publication
(10) Pub. No.: US 2021/0376788 A1
(43) Pub. Date: Dec. 2, 2021

(54) SELF-POWERED VOLTAGE RAMP FOR PHOTOVOLTAIC MODULE TESTING

(71) Applicant: Arizona Board of Regents on behalf of Arizona State University, Scottsdale, AZ (US)

(72) Inventors: Stuart Bowden, Tempe, AZ (US); Antony Aguilar, Scottsdale, AZ (US)

(73) Assignee: Arizona Board of Regents on behalf of Arizona State University, Scottsdale, AZ (US)

(21) Appl. No.: 17/263,361

(22) PCT Filed: Aug. 27, 2019
(86) PCT No.: PCT/US19/48316

§ 371 Date: Jan. 26, 2021

Related U.S. Application Data
(60) Provisional application No. 62/724,184, filed on Aug. 29, 2018.

(51) Int. Cl. H02S 50/10

(52) U.S. Cl. CPC H02S 50/10

(57) ABSTRACT

A self-powered voltage ramp for photovoltaic module testing provides a robust circuit for the measurement of current-voltage curves. A resistor and capacitor form a timer circuit to control a gate of a power transistor and give a linear voltage sweep from a short circuit (e.g., zero volts) to an open circuit voltage V_{OC}. The sweep rate can be varied by adjusting the resistor value. Additional enhancements prevent oscillations within the circuit, maintain a voltage of the power transistor within its design specifications, and allow for the measurement of single cell mini-modules. Additional circuitry can characterize the photovoltaic module based on the measurement data. Measurement accuracy is within 1% of a laboratory supply for measurements of maximum power, short circuit current, and open circuit voltage.

### RELATED APPLICATIONS

This application claims the benefit of provisional patent application Ser. No. 62/724,184, filed Aug. 29, 2018, the disclosure of which is hereby incorporated herein by reference in its entirety.

### GOVERNMENT SUPPORT

This invention was made with government support under 1041895 awarded by the National Science Foundation. The government has certain rights in the invention.

### FIELD OF THE DISCLOSURE

This application relates to testing and measurement of photovoltaic modules.

### BACKGROUND

As the photovoltaics market continues to expand, there is an increasing need for the measurement and characterization of photovoltaic modules for research purposes and commercial installations. Commercial measurement systems can provide a measurement of the current-voltage (IV) curve of a photovoltaic module. The measurement of the IV curve of a photovoltaic module from a short circuit current I_{SC} to an open circuit voltage V_{OC} provides a wealth of information on the performance and characteristics of a module. In addition to identifying the module maximum power point P_{MP}, measurement of the entire IV curve also provides additional characterization such as the parasitic resistances of shunt resistance Rₛₕᵤₙₜ and series resistance Rₛₑᵣᵢₑₛ.

Monitoring the IV curve over time can identify degradation in performance and provide additional characterization of cell parameters. It is not always known at the outset what parameters will degrade and measurement of the entire IV curve can help identify the root cause of the degradation by separating out the contributions of, for example, series or shunt resistance. Further, monitoring module performance over extended periods can give the performance for multiple irradiance levels and temperatures, along with further module characterization such as the Suns-VOC curve or the open circuit voltage V_{OC} as a function of temperature.

Modern modules are particularly challenging to measure due to their slow response times. High performance silicon solar cells have a high diffusion capacitance making flash measurements challenging and requiring slow sweep rates. For example, passivated emitter and rear cell (PERC) cells require measurement times of 300 milliseconds (ms) and record efficiency cells require measurement times up to 5 seconds (s). Module sweep times are the same as for cells when the cells are in series. For the highest performance cells currently in production, such as heterojunction cells and interdigitated back contact, a sweep time of 1 s is recommended. Current commercial measurement systems can provide this performance, but do so at a high cost.

In addition, outdoor measurements have the advantage of a uniform light source covering a large area and the spectrum of the sun can be predicted, which is typically closer to the Air Mass 1.5 (AM1.5) standard than artificial sources. The light intensity of the sun is stable for typical measurement times on clear days, and a monitor can check for fluctuations on cloudy days. There is also an obvious advantage to the measurement of modules under different climatic conditions. Measuring modules in situ would greatly speed the measurement process and a low-cost tester can increase the number of modules that can be measured simultaneously. However, the high cost of current commercial measurement systems makes such monitoring impractical.

### SUMMARY

A self-powered voltage ramp for photovoltaic module testing provides a robust circuit for the measurement of current-voltage (IV) curves. A resistor and capacitor form a timer circuit to control a gate of a power transistor and give a linear voltage sweep from a short circuit current I_{SC} (e.g., zero volts) to an open circuit voltage V_{OC}. The sweep rate can be varied by adjusting the resistor value. Additional enhancements prevent oscillations within the circuit, maintain a voltage of the power transistor within its design specifications, and allow for the measurement of single cell mini-modules. Additional circuitry can characterize the photovoltaic module based on the measurement data. Measurement accuracy is within 1% of a laboratory supply for measurements of maximum power M_{MP}, short circuit current I_{SC}, and open circuit voltage V_{OC}.

In this regard, a low cost photovoltaic measurement circuit according to this approach can serve a variety of functions, including long-term monitoring of modules in many locations and rapid, simple testing. This approach has several advantages. First, its simplicity and low cost mean that it is possible to monitor multiple locations and large numbers of modules to build up a geographically dispersed data base. Second, the circuit measures the complete IV curve, allowing analysis of degradation or other loss mechanisms as a function of time. Third, it has an easily adjustable sweep time and so is adaptable to a wide range of measurement conditions and module types.

An exemplary embodiment relates to a method for characterizing performance of a photovoltaic module. The method includes setting a voltage at a trigger node coupled to a gate of a transistor coupled across the photovoltaic module such that the photovoltaic module is short circuited. The method further includes removing the voltage at the trigger node such that a resistor-capacitor (RC) timer is coupled across the photovoltaic module and coupled to the gate of the transistor. The method further includes measuring one or more of a current through the photovoltaic module or a voltage across the photovoltaic module after removing the voltage to characterize performance of the photovoltaic module.

Another exemplary embodiment relates to a photovoltaic measurement circuit. The circuit includes a supply node and a ground node configured to couple to a photovoltaic module and a transistor coupled between the supply node and the ground node. The circuit further includes a capacitor in series with a first resistor, the capacitor being coupled to the supply node and the first resistor being coupled to the ground node. The circuit further includes a voltage trigger coupled to a gate of the transistor and configured to, in an initiation phase, enable the transistor such that the photovoltaic module is short circuited. The voltage trigger is further configured to, in a measurement phase, disable the transistor such that the capacitor and the first resistor cause a voltage across the photovoltaic module to ramp up.

Another exemplary embodiment relates to a measurement device for a photovoltaic module. The measurement device includes a supply node and a ground node configured to couple to a photovoltaic module and a measurement circuit. The measurement circuit includes a transistor coupled between the supply node and the ground node and a resistor-capacitor (RC) timer coupled between the supply node and the ground node and coupled to a gate of the transistor. The measurement circuit is configured to short circuit the photovoltaic module and, after short circuiting the photovoltaic module, disable the transistor such that the RC timer is activated. The measurement circuit is further configured to measure a voltage from the supply node to the ground node after the RC timer is activated.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an embodiment of a photovoltaic measurement circuit connected to a photovoltaic module.

FIG. 2 is a graphical representation of a linear voltage sweep as a function of sweep time using the photovoltaic measurement circuit of FIG. 1 with varying resistance values.

FIG. 3 is a schematic diagram of another embodiment of the photovoltaic measurement circuit of FIG. 1 with increased robustness and sweeping both upward and downward.

FIG. 4 is a schematic diagram of another embodiment of the photovoltaic measurement circuit of FIG. 1 with a timer implemented with an adjustable voltage divider.

FIG. 5 is a schematic diagram of another embodiment of the photovoltaic measurement circuit of FIG. 1 having an amplifier for measuring a single photovoltaic cell.

FIG. 6 is a schematic diagram of another embodiment of the photovoltaic measurement circuit of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

A self-powered voltage ramp for photovoltaic module testing provides a robust circuit for the measurement of current-voltage (IV) curves. A resistor and capacitor form a timer circuit to control a gate of a power transistor and give a linear voltage sweep from a short circuit current I_{SC} (e.g., zero volts) to an open circuit voltage V_{OC}. The sweep rate can be varied by adjusting the resistor value. Additional enhancements prevent oscillations within the circuit, maintain a voltage of the power transistor within its design specifications, and allow for the measurement of single cell mini-modules. Additional circuitry can characterize the photovoltaic module based on the measurement data. Measurement accuracy is within 1% of a laboratory supply for measurements of maximum power M_{MP}, short circuit current I_{SC}, and open circuit voltage V_{OC}.

In this regard, a low cost photovoltaic measurement circuit according to this approach can serve a variety of functions, including long-term monitoring of modules in many locations and rapid, simple testing. This approach has several advantages. First, its simplicity and low cost mean that it is possible to monitor multiple locations and large numbers of modules to build up a geographically dispersed data base. Second, the circuit measures the complete IV curve, allowing analysis of degradation or other loss mechanisms as a function of time. Third, it has an easily adjustable sweep time and so is adaptable to a wide range of measurement conditions and module types.

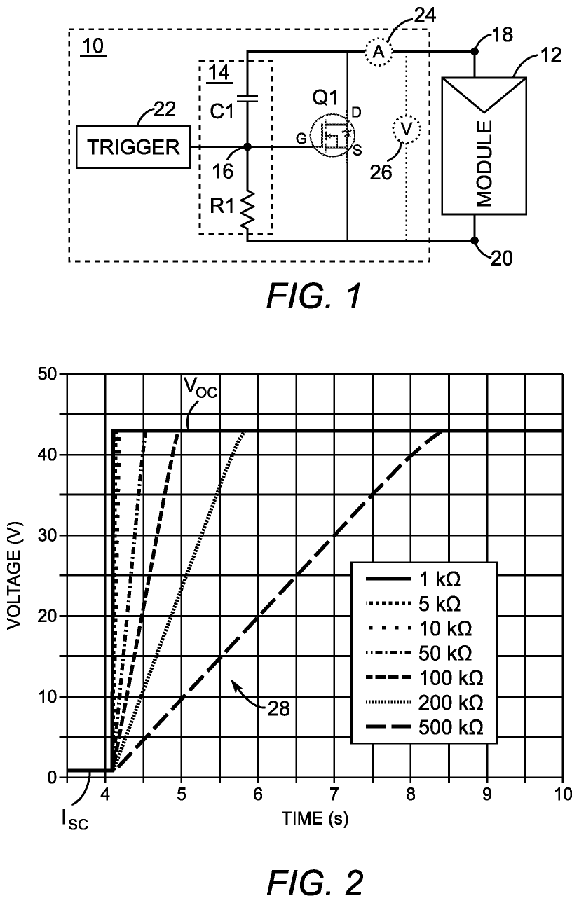

FIG. 1 is a schematic diagram of an embodiment of a photovoltaic measurement circuit 10 connected to a photovoltaic module 12. To measure the IV curve of the photovoltaic module 12, a load is varied across the terminals of the photovoltaic module 12 while simultaneously measuring the voltage and current. Ideally, the IV curve is swept all the way from the short circuit current I_{SC} to the open circuit voltage V_{OC} (or vice versa) of the photovoltaic module 12, and the load should be able to dissipate the power (e.g., 300-400 watts (W)) produced by the photovoltaic module 12 at its maximum power point P_{MP}. Sweep times should be as short as possible to reduce sensitivity to the sun's variability, but long enough so that the module remains in steady state (e.g., reducing or eliminating transient voltage and current fluctuations) throughout the measurement. As noted previously, commercial high-performance modules need sweep times of one second for reliable measurements.

One seemingly simple approach would be to use a large variable resistor, but this would be expensive and cumbersome due to the high power output of the photovoltaic module 12. Discrete resistors with a switching array are more reliable and potentially lower cost than a rheostat, but only give a limited number of data points. Another attractive technique to dissipate the power of the photovoltaic module 12 without needing large power devices would be to charge or discharge a capacitor while rapidly measuring voltage and current. This could be used on arrays as well as the photovoltaic module 12; however, slow sweep times need a large capacitor with a high voltage rating. The required capacitor size is C=(I*t)/V, where V is the average voltage in the measurement, I is the average current and t is the measurement time. Using a voltage at maximum power V_{MP} and a current at maximum power I_{MP} gives a rough approximation for the required capacitor size. For example, a 60 cell passivated emitter and rear cell (PERC) module with a voltage at maximum power V_{MP} of 35.5 volts (V) and a current at maximum power I_{MP} of 9.5 amps (A) requires a capacitor of 0.1 farads (F) to achieve a sweep time of 300 milliseconds (ms). Some photovoltaic modules 12 could require a capacitor with up to 1 F capacitance and a 50 V rating. Such capacitor banks significantly drive up the cost of this approach. An additional drawback of the capacitor approach is that it is not possible to hold the module at a fixed point (such as the maximum power point P_{MP}) for reliability studies.

In contrast, the photovoltaic measurement circuit 10 uses a transistor Q1, such as a metal-oxide-semiconductor field-effect transistor (MOSFET) or bipolar transistor, as the load. A resistor-capacitor (RC) timer 14 is provided to control a gate G of the transistor Q1, sweeping the IV curve from the short circuit current I_{SC} to the open circuit voltage V_{OC}. A simple voltage trigger can be connected to a trigger node 16 to initiate the sweep.

The photovoltaic measurement circuit 10 includes a supply node 18 and a ground node 20 configured to couple to the photovoltaic module 12. The transistor Q1 is coupled between the supply node 18 and the ground node 20 (e.g., with a drain D coupled to the supply node 18 and a source S coupled to the ground node 20 in the case of an n-type power MOSFET). In the embodiment depicted in FIG. 1, the RC timer 14 includes a capacitor C1 coupled in series with a first resistor R1, with the capacitor C1 being coupled to the supply node 18 and the first resistor R1 being coupled to the ground node 20. The trigger node 16 is between the capacitor C1 and the first resistor R1 and coupled to the gate G of the transistor Q1.

The RC timer 14 controls the gate G of the transistor Q1 to produce a linear voltage ramp. The operation of the photovoltaic measurement circuit 10 proceeds as follows: a voltage at the trigger node 16 (provided by a voltage trigger 22) is initially low so that the transistor Q1 is off. In an initiation phase, the voltage at the trigger node 16 is set significantly above a threshold voltage V_{TH} of the transistor Q1 such that the transistor Q1 is enabled and a drain to source resistance R_{DS(ON)} is close to zero. The photovoltaic module 12 is short circuited (e.g., at the short circuit current I_{SC}), and the capacitor C1 is discharged.

Then, in a measurement phase, the voltage at the trigger node 16 (and the gate G of the transistor Q1) is set to high impedance, causing the transistor Q1 to start to switch off (e.g., become disabled) and allowing the voltage of the photovoltaic module 12 to rise. However, the voltage rise is limited by the RC timer 14, which will cause the gate G of the transistor Q1 to stay close to the threshold voltage V_{TH}. Analysis proceeds by noting that the current in the first resistor I_{R1}=V_{TH}/R1, and that the current in the capacitor I_{C1}=C1*dV_{C1}/dt. Since there is very little current flowing to the gate G of the transistor Q1, the current in the resistor and capacitor are equal (i.e. I_{R1}≈I_{C1}), yielding the result:

$$\frac{d {V}_{C 1}}{dt} \approx \frac{{V}_{T H}}{R 1 C 1} \qquad Equation 1$$

The voltage across the module is the capacitor voltage V_{C1} plus the threshold voltage V_{TH} to give the result:

$$\frac{d {V}_{m o d u l e}}{dt} \approx \frac{{V}_{T H}}{R 1 C 1} \qquad Equation 2$$

Thus, the photovoltaic measurement circuit 10 produces a linear ramp rate that is adjustable by setting the product of the first resistor R1 and the capacitor C1. The threshold voltage V_{TH} also features in the equation, but it is fixed by the choice of transistor Q1 and so effectively a constant. It is typically close to 4 V. The photovoltaic measurement circuit 10 includes current measurement circuitry 24 to measure the current through the photovoltaic module 12 and voltage measurement circuitry 26 to measure voltage across the photovoltaic module 12.

FIG. 2 is a graphical representation of a linear voltage sweep as a function of sweep time using the photovoltaic measurement circuit 10 of FIG. 1 with varying resistance values. FIG. 2 illustrates plots 28 which model the photovoltaic measurement circuit 10 with the transistor Q1 being a power MOSFET with a threshold voltage V_{TH} of 5.4 volts, the capacitor C1 with capacitance of 1 μF and the photovoltaic module 12 with open circuit voltage V_{OC} of 44 V. The successive plots 28 have varying values of the first resistor R1 as noted in the legend (e.g., 1 kilohm (kΩ), 5 kΩ, 10 kΩ, 50 kΩ, 100 kΩ, 200 kΩ, 500 kΩ). The plots 28 have ramp rates which confirm the result of Equation 2 and vary from 5400 volts per second (V/s) to 10 V/s to give measurement times of 8 ms to 4.1 s simply by varying the resistor value. The ramp rates of the plots 28 are also very close to linear from the short circuit current I_{SC} to the open circuit voltage V_{OC}.

With continuing reference to FIG. 1 and FIG. 2, control of the photovoltaic measurement circuit 10 is simple since a trigger signal (from the voltage trigger 22) is only needed to initiate the sweep and it then proceeds without further control from the short circuit current I_{SC} to the open circuit voltage V_{OC}. Using the photovoltaic measurement circuit 10 as a sweep circuit eliminates the need for synchronization between control and measurement at the microcontroller. In addition to using the tri-state logic described above (where the voltage trigger 22 switches to high-impedance to initiate the sweep), it can also be connected to a logic circuit via a diode or transistor so that the sweep starts on a falling logic level or with an opto-isolator for additional electrical isolation between the control circuit and the photovoltaic module 12. In this regard, control of the photovoltaic measurement circuit 10 is provided by the voltage trigger 22, which can be implemented with a microcontroller, processing unit, or other logic device. The current measurement circuitry 24 and voltage measurement circuitry 26 can be implemented with the same or another microcontroller, processing unit, or other logic device.

The choice of components depends on the characteristics of the photovoltaic module 12. The most critical circuit component is the transistor Q1 and its ability to handle the power of the photovoltaic module 12 since it is used in linear mode and not as a switch. The most important specification is the forward-biased safe operating area (FBSOA) of the transistor Q1 (which may be termed safe operating area (SOA)), which describes the ability of the transistor Q1 to simultaneously handle the voltage and current of the photovoltaic module 12. Another critical parameter of the transistor Q1 is the drain to source resistance R_{DS(ON)}, as this determines how close the short circuit current I_{SC} measurement is to short circuit. Considering the threshold voltage V_{TH}, the voltage trigger 22 can include a logic level gate drive to simplify the interface to a microcontroller or other control device. The threshold voltage V_{TH} also determines the sweep rate (Equation 2) and while there is variation in the threshold voltage V_{TH} for a given part number, the corresponding variation in sweep rate is not large and can be corrected for by adjusting the first resistor R1 if desired.

As an example, a 60 cell photovoltaic module 12 has a maximum power point P_{MP} around 300 W, a short circuit current I_{SC} approaching 10 A, and an open circuit voltage V_{OC} around 40 V. The transistor Q1 can be implemented with a low cost MOSFET rated for 320 W of power and a drain to source resistance R_{DS(ON)} less than 45 milliohms (mΩ). The drain to source resistance R_{DS(ON)} allows for a measurement of the short circuit current I_{SC} within 0.5 V of true short circuit. The transistor Q1 also has a low threshold voltage V_{TH} for direct control from a 5 V logic circuit. A higher performance MOSFET has an even lower drain to source resistance R_{DS(ON)} of 24 mΩ, so the short circuit current I_{SC} measurement is only 240 millivolts (mV) from true short circuit. Such a transistor Q1 can also feature power handling of 575 W with a guaranteed FBSOA. This transistor Q1 can handle the output of a high performance 72 cell photovoltaic module 12 where the power approaches 400 W and the voltage approaches 50 V. The measurement time of 1 s is short so the associated heatsink does not need to be large but good thermal contact between the transistor Q1 and the heatsink is needed. For smaller photovoltaic modules 12, the choice of transistor Q1 is less critical as the current is usually smaller making the drain to source resistance R_{DS(ON)} less critical, facilitating even lower cost.

There are several possible values of the first resistor R1 and the capacitor C1 that yield a same ramp rate. However, capacitance of the capacitor C1 should be low enough so that it does not store excessive charge but high enough so the gate capacitance of the transistor Q1 does not influence the RC timer 14. In practice, this means the capacitor C1 should have a capacitance between 100 nanofarads (nF) and 1 microfarad (μF), with the first resistor R1 then adjusted to give the desired ramp rate. As discussed above, a total sweep time of 1 s covers most modules but could be set to even slower if the module has a very slow response time or if the data acquisition system is slower.

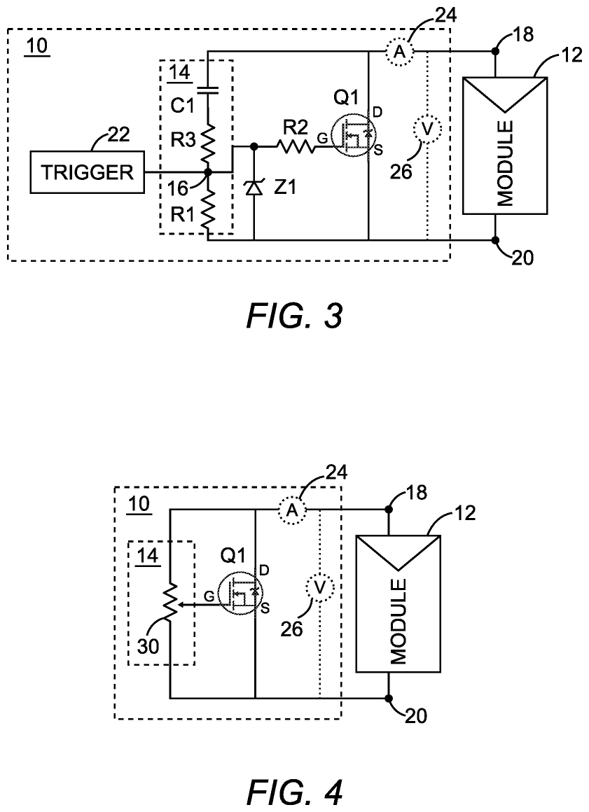

FIG. 3 is a schematic diagram of another embodiment of the photovoltaic measurement circuit 10 of FIG. 1 with increased robustness and sweeping both upward and downward. The photovoltaic measurement circuit 10 of FIG. 1 is adequate for most cases but is more stable with the addition of a second resistor R2 and a Zener diode Z1. The second resistor R2 is coupled between the trigger node 16 and the resistor at the gate G of the transistor Q1, which dampens oscillations in the photovoltaic measurement circuit 10. The zener diode Z1 is coupled between the trigger node 16 and the ground node 20 and protects the gate G of the transistor Q1 from possible voltage spikes when switching from the open circuit voltage V_{OC} to the short circuit current I_{SC}.

Other embodiments of the photovoltaic measurement circuit 10 can extend the range of the tester or facilitate use in specific applications. For example, having two resistors (the first resistor R1 and a third resistor R3) in the RC timer 14 and moving the trigger node 16 as shown in FIG. 3 gives a voltage sweep in both the forward and reverse directions. Having a dual sweep takes twice as long for a measurement but identifies hysteresis caused by metastable defects, carrier trapping or when the sweep rate is too fast. In this regard, the third resistor R3 is coupled between the trigger node 16 and the capacitor C1 such that the trigger node 16 is between the first resistor R1 and the third resistor R3.

FIG. 4 is a schematic diagram of another embodiment of the photovoltaic measurement circuit 10 of FIG. 1 with the RC timer 14 implemented with an adjustable voltage divider 30. Replacing the capacitor C1 with another resistor enables fixing the photovoltaic module 12 at a specific voltage (such as the voltage at maximum power V_{MP}) as is often desirable in reliability studies where the module needs to be kept at an operating point other than open circuit when the IV curve is not being measured. As illustrated in FIG. 4, the adjustable voltage divider 30 can be a potentiometer which controls the gate G of the transistor Q1 and thus a drain to source voltage V_{DS}, which is also the voltage across the photovoltaic module 12. The adjustable voltage divider 30 can either be used for a fixed voltage bias or to sweep from close to the short circuit current I_{SC} to the open circuit voltage V_{OC} as a manual version of the photovoltaic measurement circuit 10.

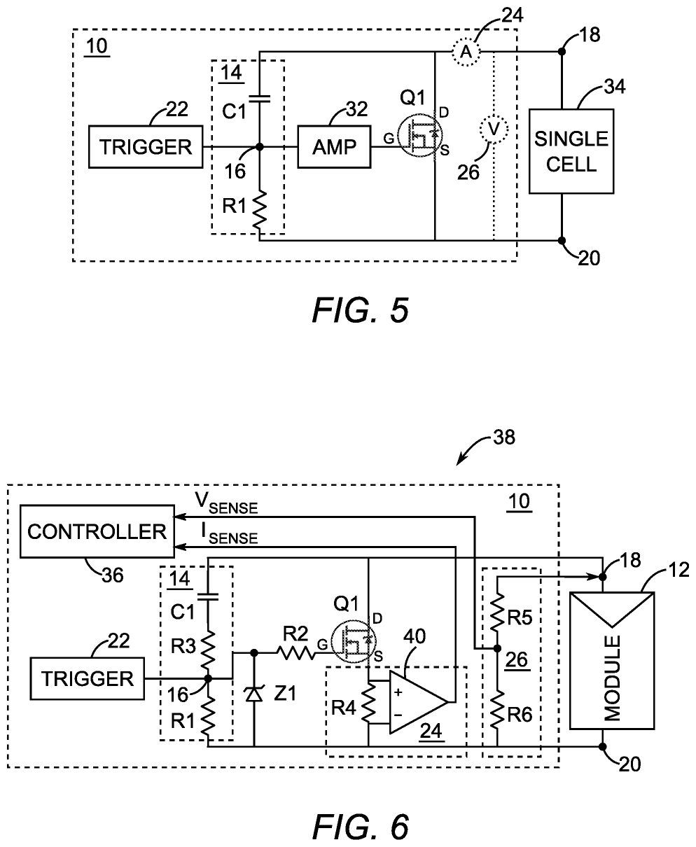

FIG. 5 is a schematic diagram of another embodiment of the photovoltaic measurement circuit 10 of FIG. 1 having an amplifier 32 for measuring a single photovoltaic cell 34. For a photovoltaic module 12 with a small number of cells in series the entire IV curve is below the threshold voltage V_{TH} of ˜4 V. An extreme case is the single photovoltaic cell 34 where the open circuit voltage V_{OC} is less than 0.75 V and the voltage ramp is no longer linear. In FIG. 5, the amplifier 32 (which can be an operational amplifier implemented in a non-inverting configuration) can have a gain of 50 and amplify the voltage at the trigger node 16. The analysis of the photovoltaic measurement circuit 10 proceeds as above except that now the voltage across the first resistor R1 in the RC timer 14 is 50 times lower than the voltage at the gate G of the transistor Q1. The sweep rate becomes:

$$\frac{d {V}_{m o d u l e}}{d t} \approx \frac{{V}_{T H}}{50 R 1 C 1} \qquad Equation 3$$

The power capability of the transistor Q1 is no longer critical since the single photovoltaic cell 34 only has a power output of 5 W. However, the single photovoltaic cell 34 has a current up to 10 A so a low drain to source resistance R_{DS(ON)} is needed for the measurement of the short circuit current I_{SC}. As an example, with the transistor Q1 being a MOSFET having a drain to source resistance R_{DS(ON)} of 1.6 mΩ the curve can extend down to within 16 mV of the true short circuit current I_{SC}. A bigger challenge when testing the single photovoltaic cell 34 is to keep the resistance of the leads coupled to the single photovoltaic cell 34 and the current measurement circuitry 24 low.

FIG. 6 is a schematic diagram of another embodiment of the photovoltaic measurement circuit 10 of FIG. 1 with a controller 36. The controller 36 provides data acquisition to measure voltage and current to the photovoltaic measurement circuit 10 and completes a measurement device 38 to generate IV curves. There are many options for the current measurement circuitry 24 and voltage measurement circuitry 26 including: an oscilloscope, an analog to digital converter (ADC), and a power meter. The controller 36 may be a microcontroller, processor, a field-programmable gate array (FPGA), a digital signal processor (DSP), an application-specific integrated circuit (ASIC), or other programmable logic device, a discrete gate or transistor logic, discrete hardware components, or any combination thereof. The controller 36 may also control or be integrated with the voltage trigger 22 and designed to perform the functions described herein.

FIG. 6 shows an exemplary embodiment of the photovoltaic measurement circuit 10 for a 60-cell photovoltaic module 12. The photovoltaic measurement circuit 10 is illustrated with the configuration of FIG. 3, but it should be understood that any of the embodiments of FIGS. 1-5 may include the controller 36, the current measurement circuitry 24, and the voltage measurement circuitry 26 of FIG. 6. The current measurement circuitry 24 includes a fourth resistor R4 which develops a voltage proportional to the current that can either be measured directly or via a differential amplifier 40. For example, the differential amplifier 40 can have a gain of 20 to produce 1 V at the controller 36 for a current through the supply node 18 of 10 A. The voltage measurement circuitry 26 is a voltage divider which includes a fifth resistor R5 (with a resistance of 47 kΩ as an example) and a sixth resistor R6 (with a resistance of 1 kΩ as an example).

Those skilled in the art will recognize improvements and modifications to the preferred embodiments of the present disclosure. All such improvements and modifications are considered within the scope of the concepts disclosed herein and the claims that follow.

What is claimed is:

1. A method for characterizing performance of a photovoltaic module, comprising:
setting a voltage at a trigger node coupled to a gate of a transistor coupled across the photovoltaic module such that the photovoltaic module is short circuited;
removing the voltage at the trigger node such that a resistor-capacitor (RC) timer is coupled across the photovoltaic module and coupled to the gate of the transistor; and
measuring one or more of a current through the photovoltaic module or a voltage across the photovoltaic module after removing the voltage to characterize performance of the photovoltaic module.

2. The method of claim 1, wherein the RC timer causes the voltage across the photovoltaic module to ramp up linearly after removing the voltage at the trigger node.

3. The method of claim 2, wherein the RC timer further causes the voltage across the photovoltaic module to ramp down linearly after ramping up.

4. The method of claim 1, wherein measuring the one or more of the current through the photovoltaic module or the voltage across the photovoltaic module comprises measuring the current through the photovoltaic module and the voltage across the photovoltaic module.

5. The method of claim 4, further comprising producing a current-voltage (I-V) curve from a short circuit current I_{SC} to an open circuit voltage V_{OC} to characterize performance of the photovoltaic module.

6. The method of claim 1, wherein:
the transistor comprises a metal-oxide-semiconductor field-effect transistor (MOSFET) having a safe operating voltage and current area; and
the method further comprises maintaining the MOSFET in the safe operating voltage and current area with a Zener diode coupled to the gate of the MOSFET.

7. A photovoltaic measurement circuit, comprising:
a supply node and a ground node configured to couple to a photovoltaic module;
a transistor coupled between the supply node and the ground node;
a capacitor in series with a first resistor, the capacitor being coupled to the supply node and the first resistor being coupled to the ground node; and
a voltage trigger coupled to a gate of the transistor and configured to:
in an initiation phase, enable the transistor such that the photovoltaic module is short circuited; and
in a measurement phase, disable the transistor such that the capacitor and the first resistor cause a voltage across the photovoltaic module to ramp up.

8. The circuit of claim 7, wherein the voltage trigger is further coupled to a trigger node between the capacitor and the first resistor.

9. The circuit of claim 8, further comprising a second resistor coupled between the trigger node and the gate of the transistor.

10. The circuit of claim 9, further comprising a third resistor coupled between the trigger node and the capacitor.

11. The circuit of claim 9, further comprising a Zener diode coupled between the trigger node and the ground node.

12. The circuit of claim 7, wherein the first resistor comprises an adjustable resistor.

13. The circuit of claim 7, wherein the supply node and the ground node are configured to couple to the photovoltaic module comprising a single photovoltaic cell.

14. The circuit of claim 13, further comprising an amplifier coupled between the voltage trigger and the gate of the transistor.

15. The circuit of claim 7, wherein the transistor comprises a metal-oxide-semiconductor field-effect transistor (MOSFET).

16. A measurement device for a photovoltaic module, comprising:
a supply node and a ground node configured to couple to a photovoltaic module; and
a measurement circuit, comprising:
a transistor coupled between the supply node and the ground node; and
a resistor-capacitor (RC) timer coupled between the supply node and the ground node and coupled to a gate of the transistor;
wherein the measurement circuit is configured to:
short circuit the photovoltaic module;
after short circuiting the photovoltaic module, disable the transistor such that the RC timer is activated; and
measure a voltage from the supply node to the ground node after the RC timer is activated.

17. The measurement device of claim 16, wherein the measurement circuit is further configured to measure a current through the supply node after the RC timer is activated.

18. The measurement device of claim 17, wherein the measurement circuit further comprises an analog-to-digital converter which measures the voltage from the supply node to the ground node and measures the current through the supply node.

19. The measurement device of claim 16, wherein the RC timer comprises:
a capacitor coupled to the supply node;
a first resistor coupled to the ground node; and
a trigger node between the capacitor and the first resistor coupled to the gate of the transistor.

20. The measurement device of claim 19, further comprising a second resistor coupled between the trigger node and the first resistor;
wherein the RC timer causes the voltage from the supply node to the ground node to sweep up to an open circuit voltage and down to a short circuit.
